(19) United States
(12) Patent Application Publication
(10) Pub. No.: US 2016/0154724 A1
(43) Pub. Date: Jun. 2, 2016

(54) NON-FUNCTIONAL EVALUATION ASSISTANCE DEVICE, SYSTEM, METHOD, AND PROGRAM

(71) Applicant: NEC CORPORATION, Tokyo (JP)

(72) Inventor: Hiroshi SAKAKI, Tokyo (JP)

(21) Appl. No.: 14/900,378

(22) PCT Filed: May 30, 2014
(86) PCT No.: PCT/JP2014/002886

§ 371 Date: Dec. 21, 2015

(30) Foreign Application Priority Data
Jun. 28, 2013 (JP) 2013-135914

(51) Int. Cl. G06F 11/34

(52) U.S. Cl. CPC G06F 11/3447

(57) ABSTRACT

A non-functional evaluation assistance device includes: system model selection means 21 for selecting and extracting a system model representing a system to be evaluated; case script selection means 22 for selecting and extracting a case script corresponding to the system to be evaluated; task parameter input item generation means 23 for generating a task parameter input item; task parameter input means 24 for receiving input of a task parameter; non-functional evaluation parameter calculation means 25 for calculating a non-functional evaluation parameter based on the input task parameter and the case script; and non-functional evaluation calculation means 26 for outputting a non-functional evaluation calculation result which is a result for evaluating a non-functional requirement of the system to be evaluated, based on the calculated non-functional evaluation parameter and the system model, the non-functional requirement being defined according to a user request.

### TECHNICAL FIELD

The present invention relates to a non-functional evaluation assistance device, a non-functional evaluation assistance system, a non-functional evaluation assistance method, and a non-functional evaluation assistance program. The present invention particularly relates to a non-functional evaluation assistance device, non-functional evaluation assistance system, non-functional evaluation assistance method, and non-functional evaluation assistance program capable of easily determining information necessary for predicting beforehand a non-functional requirement of a system to be evaluated in the field of system integration.

### BACKGROUND ART

An example of a typical system for evaluating network performance is described in each of Patent Literatures (PTL) 1 and 2. A network simulation system described in PTL 1 includes a database device, traffic foundation modeling means, and network simulation system execution means.

The network simulation system described in PTL 1 creates, on a business process indicating flow of business operation, interaction between nodes corresponding to objects of the business operation, associates the business process with traffic information, and generates a network including the traffic information. The network simulation system evaluates the performance of the network by simulation performed by the network simulation execution means, thus evaluating the performance with the corresponding traffic.

A performance evaluation system described in PTL 2 generates a performance evaluation model for evaluating the performance of a virtualized system, and evaluates the performance of the virtualized system based on the performance evaluation model.

### CITATION LIST

### Patent Literature(s)

PTL 1: Japanese Patent Application Laid-Open No. 2003-178103

PTL 2: Japanese Patent Application Laid-Open No. 2012-146015

### SUMMARY OF INVENTION

### Technical Problem

The typical techniques described in PTL 1 and PTL 2 have a problem in that it is difficult to determine information necessary for evaluating not only a function constituting a system but also a non-functional requirement which is a system requirement defined according to a user request, and so it is difficult to evaluate the non-functional requirement using appropriate information. The reason for this is as follows. With the above-mentioned typical techniques, non-functional evaluation parameters necessary for non-functional evaluation, such as the number of users and the number of simultaneous connections, cannot be measured before establishing the system. The user accordingly needs to estimate these non-functional evaluation parameters based on high-level knowledge and past experience.

The typical techniques described in PTL 1 and PTL 2 also have a problem in that an element for evaluating the non-functional requirement beforehand, such as an application executed on the system, is unknown, which makes it difficult to appropriately evaluate the non-functional requirement.

The present invention has an object of providing a non-functional evaluation assistance device, non-functional evaluation assistance system, non-functional evaluation assistance method, and non-functional evaluation assistance program capable of easily evaluating a non-functional requirement of a system.

### Solution to Problem

A non-functional evaluation assistance device according to the present invention includes: system model selection means for selecting and extracting, from a system model stored beforehand, a system model representing a system to be evaluated; case script selection means for selecting and extracting, from a case script stored beforehand and representing a case executed in a system, a case script corresponding to the system to be evaluated; task parameter input item generation means for generating a task parameter input item based on the selected case script; task parameter input means for presenting the task parameter input item, and receiving input of a task parameter from a user; non-functional evaluation parameter calculation means for calculating a non-functional evaluation parameter based on the input task parameter and the case script; and non-functional evaluation calculation means for outputting a non-functional evaluation calculation result which is a result for evaluating a non-functional requirement of the system to be evaluated, based on the calculated non-functional evaluation parameter and the system model, the non-functional requirement being defined according to a user request.

A non-functional evaluation assistance system according to the present invention includes: system model storage means for storing a system model; system model selection means for selecting and extracting, from the system model, a system model representing a system to be evaluated; case script storage means for storing a case script representing a case executed in a system; case script selection means for selecting and extracting, from the case script, a case script corresponding to the system to be evaluated; task parameter input item generation means for generating a task parameter input item based on the selected case script; task parameter input means for presenting the task parameter input item, and receiving input of a task parameter from a user; non-functional evaluation parameter calculation means for calculating a non-functional evaluation parameter based on the input task parameter and the case script; and non-functional evaluation calculation means for outputting a non-functional evaluation calculation result which is a result for evaluating a non-functional requirement of the system to be evaluated, based on the calculated non-functional evaluation parameter and the system model, the non-functional requirement being defined according to a user request.

A non-functional evaluation assistance method according to the present invention includes: selecting and extracting, from a system model stored beforehand, a system model representing a system to be evaluated; selecting and extracting, from a case script stored beforehand and representing a case executed in a system, a case script corresponding to the system to be evaluated; generating a task parameter input item based on the selected case script; presenting the task parameter input item, and receiving input of a task parameter from a user; calculating a non-functional evaluation parameter based on the input task parameter and the case script; and outputting a non-functional evaluation calculation result which is a result for evaluating a non-functional requirement defined according to a user request, based on the calculated non-functional evaluation parameter and the system model.

A non-functional evaluation assistance program according to the present invention causes a computer to execute: a system model selection process of selecting and extracting, from a system model stored beforehand, a system model representing a system to be evaluated; a case script selection process of selecting and extracting, from a case script stored beforehand and representing a case executed in a system, a case script corresponding to the system to be evaluated; a task parameter input item generation process of generating a task parameter input item based on the selected case script; a task parameter input process of presenting the task parameter input item, and receiving input of a task parameter from a user; a non-functional evaluation parameter calculation process of calculating a non-functional evaluation parameter based on the input task parameter and the case script; and a non-functional evaluation calculation process of outputting a non-functional evaluation calculation result which is a result for evaluating a non-functional requirement of the system to be evaluated, based on the calculated non-functional evaluation parameter and the system model, the non-functional requirement being defined according to a user request.

### Advantageous Effects of Invention

According to the present invention, a non-functional requirement of a system can be easily evaluated.

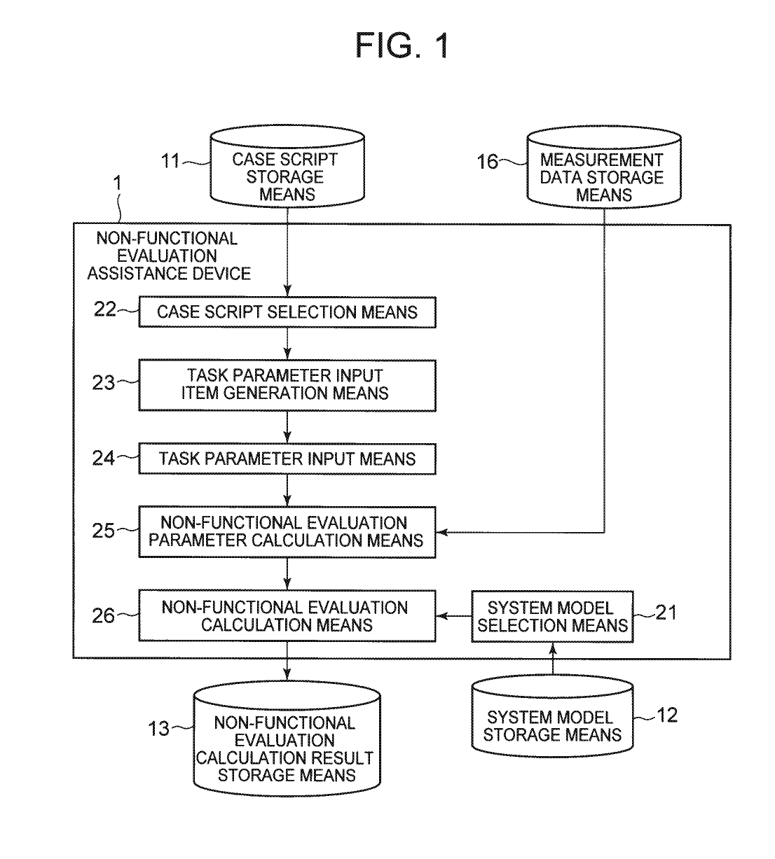

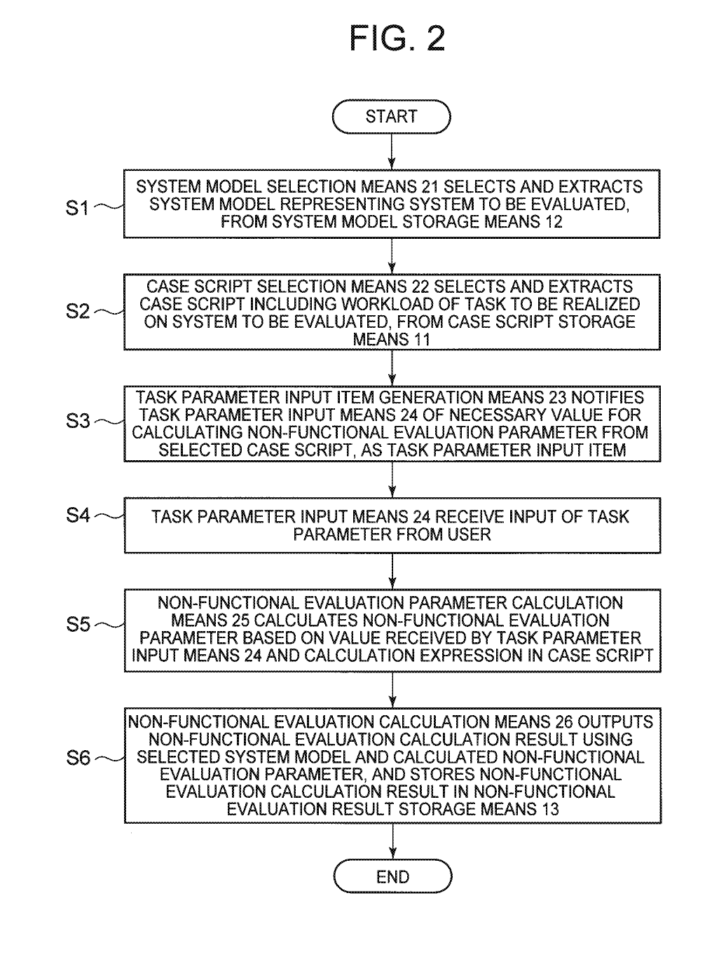

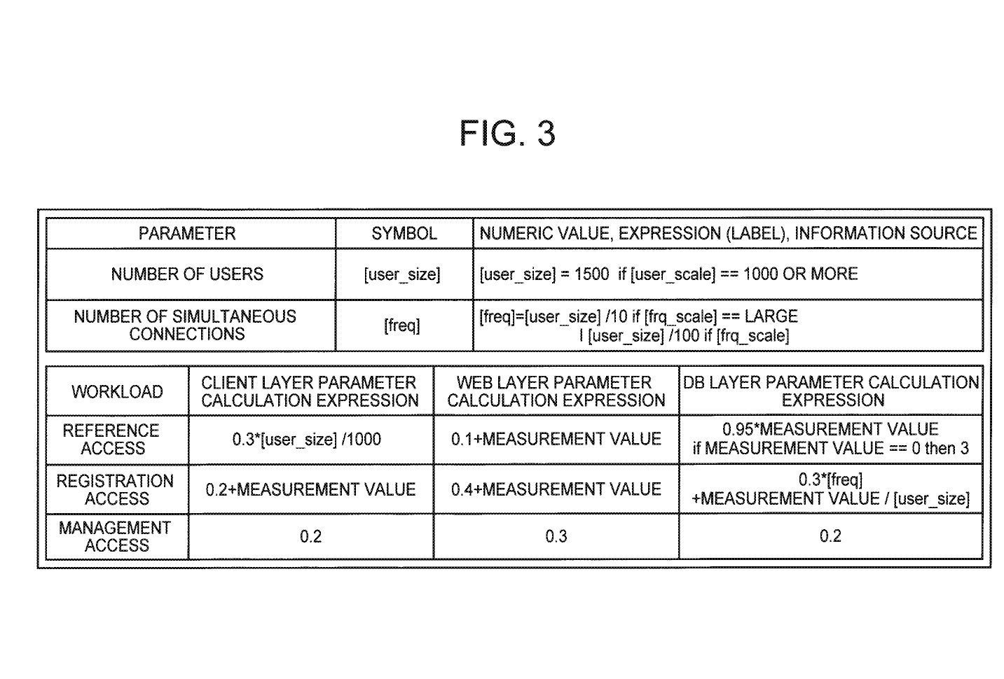

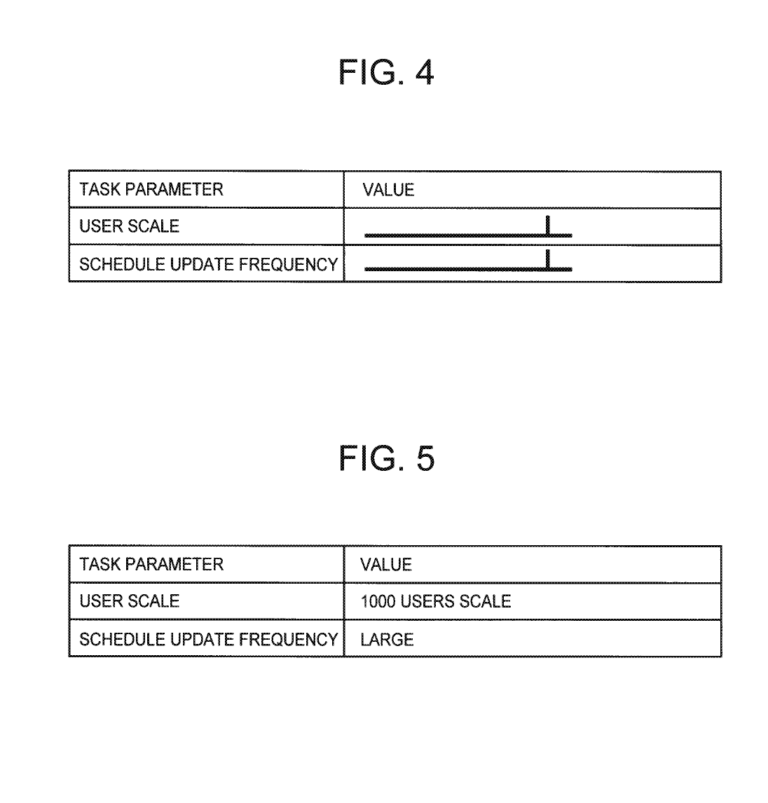

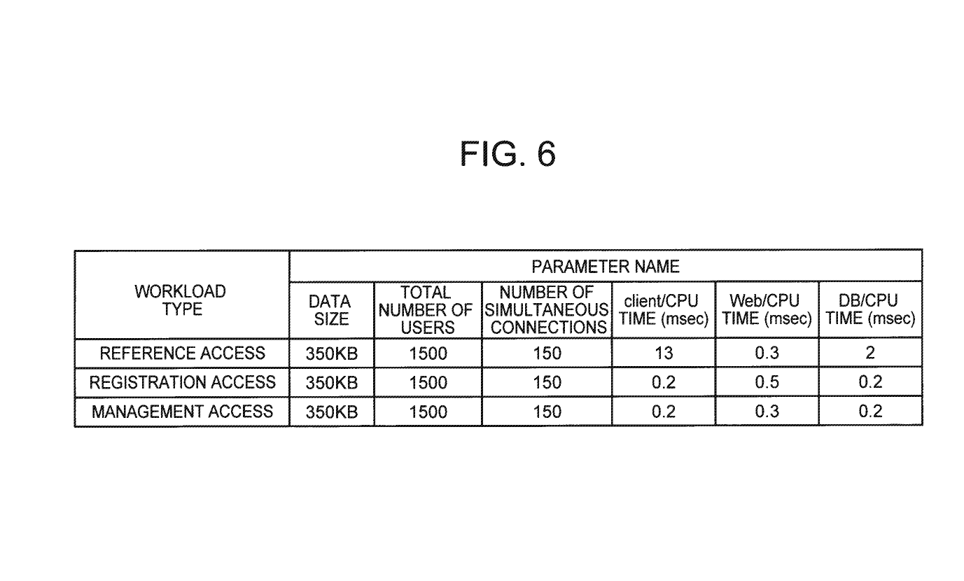

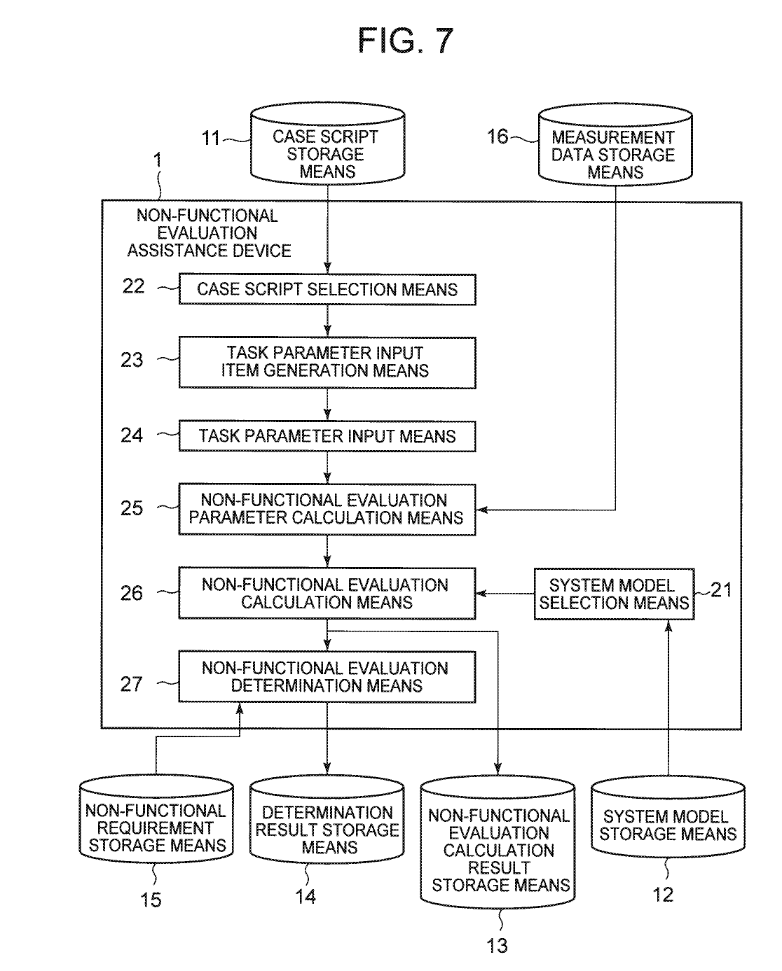

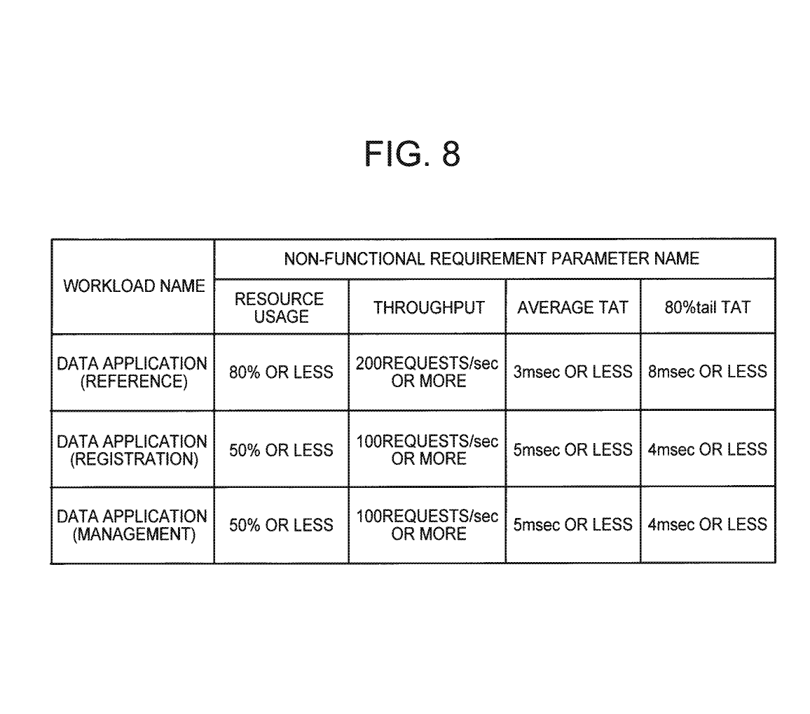

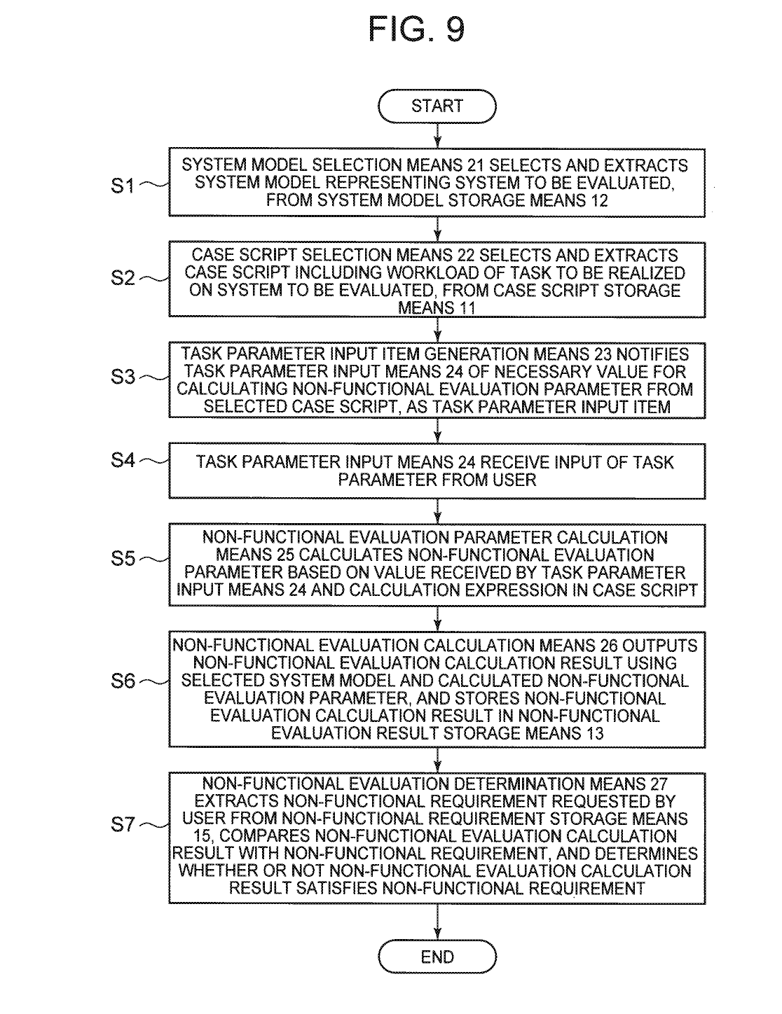

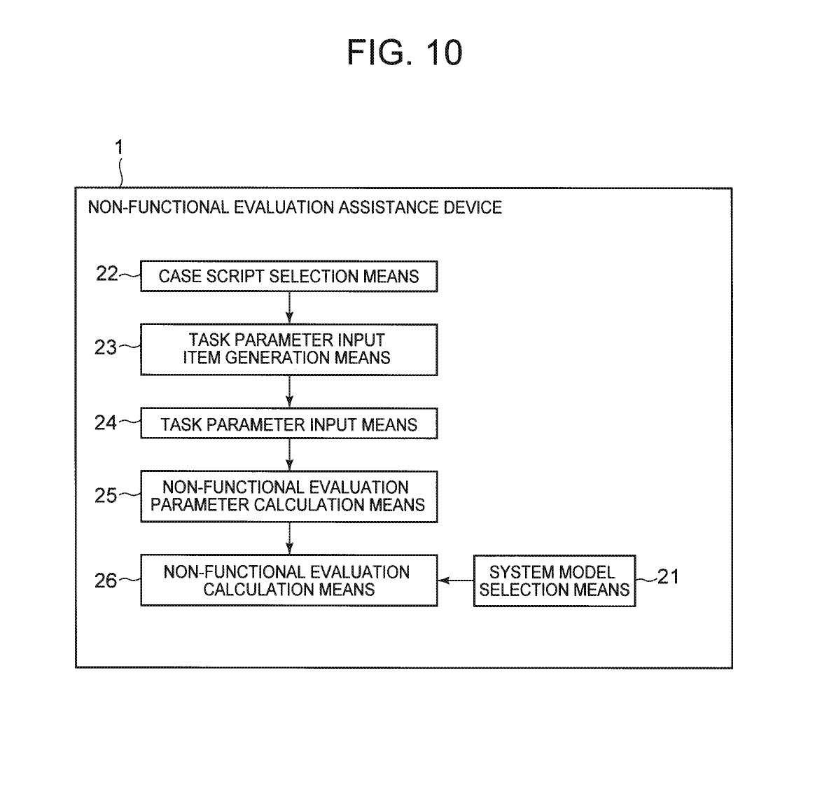

### BRIEF DESCRIPTION OF DRAWINGS

[FIG. 1] It is a block diagram depicting the structure of a first exemplary embodiment of a non-functional evaluation assistance system according to the present invention.

[FIG. 2] It is a flowchart depicting the operation of the first exemplary embodiment of the non-functional evaluation assistance system according to the present invention.

[FIG. 3] It is an explanatory diagram depicting a specific example of a case script.

[FIG. 4] It is an explanatory diagram depicting a specific example of a screen for inputting values in task parameter input items.

[FIG. 5] It is an explanatory diagram depicting a specific example of a screen in which the values have been input in the task parameter input items.

[FIG. 6] It is an explanatory diagram depicting a specific example of non-functional requirement evaluation parameters.

[FIG. 7] It is a block diagram depicting the structure of a second exemplary embodiment of a non-functional evaluation assistance system according to the present invention.

[FIG. 8] It is an explanatory diagram depicting a specific example of non-functional requirements stored in non-functional requirement storage means.

[FIG. 9] It is a flowchart depicting the operation of the second exemplary embodiment of the non-functional evaluation assistance system according to the present invention.

[FIG. 10] It is a block diagram depicting the structure of main parts of a non-functional evaluation assistance device according to the present invention.

### DESCRIPTION OF EMBODIMENT(S)

The following describes exemplary embodiments of a non-functional evaluation assistance device according to the present invention, with reference to drawings.

### Exemplary Embodiment 1

FIG. 1 is a block diagram depicting the structure of a non-functional evaluation assistance system in a first exemplary embodiment (Exemplary Embodiment 1). As depicted in FIG. 1, the non-functional evaluation assistance system in this exemplary embodiment includes a non-functional evaluation assistance device 1, case script storage means 11, system model storage means 12, non-functional evaluation calculation result storage means 13, and measurement data storage means 16. The non-functional evaluation assistance device 1 includes system model selection means 21, case script selection means 22, task parameter input item generation means 23, task parameter input means 24, non-functional evaluation parameter calculation means 25, and non-functional evaluation calculation means 26.

The system model selection means 21, the case script selection means 22, the task parameter input item generation means 23, the task parameter input means 24, the non-functional evaluation parameter calculation means 25, and the non-functional evaluation calculation means 26 are, for example, realized by an information processing device such as a central processing unit (CPU) operating according to a program or hardware designed to perform specific computation and the like.

The case script storage means 11 stores each case script that represents a case executed on a system to be evaluated and includes a calculation expression for calculating a non-functional evaluation parameter. The case script includes a calculation expression for calculating a non-functional evaluation parameter of a system model based on information determined according to user behavior such as user scale and update frequency necessary for non-functional evaluation of the system.

FIG. 3 is an explanatory diagram depicting a specific example of a case script. FIG. 3 depicts an example of a case script stored in the case script storage means 11, which represents a case when a user executes a schedule task on a web three-layer system model. In FIG. 3, [user_scale] indicates user scale, and [frq_scale] indicates update frequency. Values received by the below-mentioned task parameter input means 24 are used as these values. Moreover, a value stored in the measurement data storage means 16 is set in the “measurement value” in the mathematical expressions depicted in FIG. 3.

The system model is, for example, written using typical modeling notation such as the Unified Modeling Language (UML) as described in PTL 2. The attribute described in PTL 2 may be equally used for the non-functional evaluation parameter.

The system model storage means 12 stores a model including the structure and flow of the system to be evaluated and attributes for performing non-functional evaluation. This model may be such a system model as described in PTL 2.

The measurement data storage means 16 stores each value obtained by measuring CPU time (the time during which the CPU is used in program execution) or the like in a test environment or an actual environment.

The system model selection means 21 selects and extracts a system model representing the system to be evaluated, from the models stored in the system model storage means 12.

The case script selection means 22 selects and extracts a case script that corresponds to the system model of the system to be evaluated and includes a workload of a task to be realized on the system to be evaluated, from the case script storage means 11.

The task parameter input item generation means 23 generates a task parameter input item based on the selected case script. In detail, the task parameter input item generation means 23 extracts the workload and parameter-related calculation expression from the selected case script. The task parameter input item generation means 23 then notifies the task parameter input means 24 of the necessary value for calculating the non-functional evaluation parameter, as a task parameter input item.

The task parameter input means 24 receives input of a task parameter from a user. In detail, the task parameter input means 24 presents the task parameter input item acquired from the task parameter input item generation means 23 on a screen of a display device or the like, and receives input of a task parameter from the user.

FIG. 4 is an explanatory diagram depicting a specific example of a screen for inputting values in task parameter input items. The input items depicted in FIG. 4 correspond to the task parameters extracted from the case script depicted in FIG. 3. FIG. 5 is an explanatory diagram depicting a specific example of a screen in which the values have been input in the task parameter input items.

As depicted in FIG. 5, the task parameters include user scale and schedule update frequency. The user scale is the scale of the number of users of the system. The update frequency is not limited to schedule update frequency, and may be update frequency for any item as long as it is the update frequency of data in the system by the user.

The non-functional evaluation parameter calculation means 25 calculates the non-functional evaluation parameter, based on the task parameter received by the task parameter input means 24 and the calculation expression in the case script. In the case where the measurement value is necessary in this calculation as in the case script depicted in FIG. 3, the non-functional evaluation parameter calculation means 25 uses measurement data stored in the measurement data storage means 16 as the measurement value.

FIG. 6 is an explanatory diagram depicting an example of non-functional requirement evaluation parameters. The non-functional requirement evaluation parameters depicted in FIG. 6 are calculated based on the task parameters input by the user depicted in FIG. 5 and the case script depicted in FIG. 3.

The non-functional evaluation calculation means 26 executes non-functional evaluation based on the calculated non-functional evaluation parameter and the system model, and outputs a non-functional evaluation calculation result. The non-functional evaluation calculation result is a result for evaluating a non-functional requirement of the system to be evaluated, where the non-functional requirement is defined according to a user request. For example, the non-functional evaluation calculation means 26 generates, based on the non-functional evaluation parameter and the system model, a performance evaluation model in the same way as the performance evaluation model generation means described in PTL 2, and executes simulation using the performance evaluation model to thereby execute non-functional evaluation.

The non-functional evaluation calculation result storage means 13 stores the non-functional evaluation calculation result output from the non-functional evaluation calculation means 26.

The following describes the operation of the non-functional evaluation assistance system in this exemplary embodiment. FIG. 2 is a flowchart depicting the operation of the non-functional evaluation assistance system in this exemplary embodiment.

First, the system model selection means 21 selects and extracts the system model representing the system to be evaluated, from the models stored in the system model storage means 12 (step S1).

Next, the case script selection means 22 selects and extracts the case script that corresponds to the system model of the system to be evaluated and represents the case executed on the system to be evaluated, from the case script storage means 11 (step S2).

Next, the task parameter input item generation means 23 extracts the workload and parameter-related calculation expression from the selected case script, and notifies the task parameter input means 24 of the necessary value for calculating the non-functional evaluation parameter, as the task parameter input item (step S3).

Next, the task parameter input means 24 receives input of the task parameter from the user (step S4). In detail, the task parameter input means 24 presents the task parameter input item notified from the task parameter input item generation means 23 on a screen of a display device or the like, and receives input of the task parameter from the user.

Next, the non-functional evaluation parameter calculation means 25 calculates the non-functional evaluation parameter, based on the value received by the task parameter input means 24 and the calculation expression in the case script (step S5). The non-functional evaluation parameter calculation means 25 may use the measurement data stored in the measurement data storage means 16 as the measurement value.

Lastly, the non-functional evaluation calculation means 26 performs non-functional evaluation using the selected system model and the calculated non-functional evaluation parameter, and stores the evaluation result in the non-functional evaluation calculation result storage means 13 (step S6).

The following describes the advantageous effects of the non-functional evaluation assistance system in this exemplary embodiment. The non-functional evaluation assistance system acquires, based on the case script stored beforehand, the task parameter necessary for evaluating the non-functional requirement from the user, and calculates the non-functional evaluation parameter using the task parameter. The non-functional evaluation assistance system can perform non-functional evaluation based on the non-functional evaluation parameter and the system model stored beforehand. Thus, the non-functional evaluation of the system to be established can be easily performed in advance before the establishment of the system. This is because the user only needs to input the task parameter in order to calculate the non-functional evaluation parameter, and does not need to estimate the non-functional evaluation parameter based on high-level knowledge and past experience.

### Exemplary Embodiment 2

FIG. 7 is a block diagram depicting the structure of a non-functional evaluation assistance system in a second exemplary embodiment (Exemplary Embodiment 2). The non-functional evaluation assistance system in this exemplary embodiment includes non-functional evaluation determination means 27, determination result storage means 14, and non-functional requirement storage means 15, in addition to the structure in the first exemplary embodiment depicted in FIG. 1. The description of the same components as those in the first exemplary embodiment is omitted here.

The non-functional requirement storage means 15 stores a non-functional requirement defined according to a user request, other than a function constituting the system. The non-functional requirement storage means 15 stores beforehand the requirement requested by the user.

FIG. 8 is an explanatory diagram depicting a specific example of non-functional requirements stored in the non-functional requirement storage means. As depicted in FIG. 8, the non-functional requirements include resource usage, throughput, average turnaround time (TAT), and 80% tail TAT.

The non-functional evaluation determination means 27 extracts the non-functional requirement requested by the user from the non-functional requirement storage means 15, compares the non-functional evaluation calculation result with the non-functional requirement, and determines whether or not the non-functional evaluation calculation result satisfies the non-functional requirement. The non-functional evaluation determination means 27 stores the determination result in the determination result storage means 14.

The determination result storage means 14 stores the determination result output from the non-functional evaluation determination means 27.

FIG. 9 is a flowchart depicting the operation of the non-functional evaluation assistance system in this exemplary embodiment. In FIG. 9, steps S1 to S6 are the same as those in the first exemplary embodiment depicted in FIG. 2, and so their description is omitted.

The non-functional evaluation determination means 27 extracts the non-functional requirement requested by the user from the non-functional requirement storage means 15, compares the non-functional evaluation calculation result with the non-functional requirement, and determines whether or not the non-functional evaluation calculation result satisfies the non-functional requirement (step S7). The non-functional evaluation determination means 27 stores the determination result in the determination result storage means 14.

The non-functional evaluation assistance system in this exemplary embodiment evaluates the non-functional evaluation calculation result using the non-functional requirement stored in the non-functional requirement storage means 15 beforehand. The non-functional evaluation of the system can thus be easily performed.

FIG. 10 is a block diagram depicting the structure of main parts of a non-functional evaluation assistance device according to the present invention. As depicted in FIG. 10, a non-functional evaluation assistance device 1 according to the present invention includes, as main components: system model selection means 21 for selecting and extracting, from a system model stored beforehand, a system model representing a system to be evaluated; case script selection means 22 for selecting and extracting, from a case script stored beforehand and representing a case executed in a system, a case script corresponding to the system to be evaluated; task parameter input item generation means 23 for generating a task parameter input item based on the selected case script; task parameter input means 24 for presenting the task parameter input item, and receiving input of a task parameter from a user; non-functional evaluation parameter calculation means 25 for calculating a non-functional evaluation parameter based on the input task parameter and the case script; and non-functional evaluation calculation means 26 for outputting a non-functional evaluation calculation result which is a result for evaluating a non-functional requirement of the system to be evaluated, based on the calculated non-functional evaluation parameter and the system model, the non-functional requirement being defined according to a user request.

Each of the foregoing exemplary embodiments also discloses the following non-functional evaluation assistance devices (1) to (3).

(1) The non-functional evaluation assistance device includes non-functional evaluation determination means (e.g. non-functional evaluation determination means 27) for comparing the non-functional evaluation calculation result with the non-functional requirement stored beforehand, and determining whether or not the non-functional evaluation calculation result satisfies the non-functional requirement. Such a non-functional evaluation assistance device can easily perform non-functional evaluation on the system.

(2) In the non-functional evaluation assistance device, the task parameter may include a scale of users of the system. Such a non-functional evaluation assistance device can evaluate the non-functional requirement of the system in consideration of the scale of users.

(3) In the non-functional evaluation assistance device, the task parameter may include an update frequency of data in the system by a user. Such a non-functional evaluation assistance device can evaluate the non-functional requirement of the system in consideration of the update frequency of data in the system.

This application claims priority based on Japanese Patent Application No. 2013-135914 filed on Jun. 28, 2013, the disclosure of which is incorporated herein in its entirety.

Although the present invention has been described with reference to the foregoing exemplary embodiments, the present invention is not limited to the foregoing exemplary embodiments. Various changes understandable by those skilled in the art can be made to the structures and details of the present invention within the scope of the present invention.

### INDUSTRIAL APPLICABILITY

The present invention is applicable to performance evaluation of a network before establishment.

### Reference Signs List

1 non-functional evaluation assistance device
11 case script storage means
12 system model storage means
13 non-functional evaluation calculation result storage means
14 determination result storage means
15 non-functional requirement storage means
16 measurement data storage means
21 system model selection means
22 case script selection means
23 task parameter input item generation means
24 task parameter input means
25 non-functional evaluation parameter calculation means
26 non-functional evaluation calculation means
27 non-functional evaluation determination means

What is claimed is:

1. A non-functional evaluation assistance device comprising:
system model selection unit which selects and extracts, from a system model stored beforehand, a system model representing a system to be evaluated;
case script selection unit which selects and extracts, from a case script stored beforehand and representing a case executed in a system, a case script corresponding to the system to be evaluated;
task parameter input item generation unit which generates a task parameter input item based on the selected case script;
task parameter input unit which presents the task parameter input item, and receiving input of a task parameter from a user;
non-functional evaluation parameter calculation unit which calculates a non-functional evaluation parameter based on the input task parameter and the case script; and
non-functional evaluation calculation unit which outputs a non-functional evaluation calculation result which is a result for evaluating a non-functional requirement of the system to be evaluated, based on the calculated non-functional evaluation parameter and the system model, the non-functional requirement being defined according to a user request.

2. The non-functional evaluation assistance device according to claim 1, comprising
non-functional evaluation determination unit which compares the non-functional evaluation calculation result with the non-functional requirement stored beforehand, and determines whether or not the non-functional evaluation calculation result satisfies the non-functional requirement.

3. The non-functional evaluation assistance device according to claim 1, wherein the task parameter includes a scale of users of the system.

4. The non-functional evaluation assistance device according to claim 1, wherein the task parameter includes an update frequency of data in the system by a user.

5. The non-functional evaluation assistance device according to claim 1, comprising
system model storage unit which stores the system model; and
case script storage unit which stores the case script representing the case executed in the system.

6. The non-functional evaluation assistance device according to claim 1, comprising:
non-functional requirement storage unit which stores the non-functional requirement; and
non-functional evaluation determination unit which compares the non-functional evaluation calculation result with the non-functional requirement, and determines whether or not the non-functional evaluation calculation result satisfies the non-functional requirement.

7. A non-functional evaluation assistance method comprising:
selecting and extracting, from a system model stored beforehand, a system model representing a system to be evaluated;
selecting and extracting, from a case script stored beforehand and representing a case executed in a system, a case script corresponding to the system to be evaluated;
generating a task parameter input item based on the selected case script;
presenting the task parameter input item, and receiving input of a task parameter from a user;
calculating a non-functional evaluation parameter based on the input task parameter and the case script; and
outputting a non-functional evaluation calculation result which is a result for evaluating a non-functional requirement defined according to a user request, based on the calculated non-functional evaluation parameter and the system model.

8. The non-functional evaluation assistance method according to claim 7, comprising
comparing the non-functional evaluation calculation result with the non-functional requirement stored beforehand, and determining whether or not the non-functional evaluation calculation result satisfies the non-functional requirement.

9. A non-transitory computer readable information recording medium storing a non-functional evaluation assistance program that, when executed by a processor, performs a method for:
selecting and extracting, from a system model stored beforehand, a system model representing a system to be evaluated;
selecting and extracting, from a case script stored beforehand and representing a case executed in a system, a case script corresponding to the system to be evaluated;
generating a task parameter input item based on the selected case script;
presenting the task parameter input item, and receiving input of a task parameter from a user;
calculating a non-functional evaluation parameter based on the input task parameter and the case script; and
outputting a non-functional evaluation calculation result which is a result for evaluating a non-functional requirement of the system to be evaluated, based on the calculated non-functional evaluation parameter and the system model, the non-functional requirement being defined according to a user request.

10. The non-transitory computer readable information recording medium storing a non-functional evaluation assistance program according to claim 9 that, when executed by a processor, performs a method for: comparing the non-functional evaluation calculation result with the non-functional requirement stored beforehand, and determining whether or not the non-functional evaluation calculation result satisfies the non-functional requirement.

11. The non-functional evaluation assistance device according to claim 2, wherein the task parameter includes a scale of users of the system.

12. The non-functional evaluation assistance device according to claim 2, wherein the task parameter includes an update frequency of data in the system by a user.

13. The non-functional evaluation assistance device according to claim 3, wherein the task parameter includes an update frequency of data in the system by a user.

14. The non-functional evaluation assistance device according to claim 2, comprising
system model storage unit which stores the system model; and
case script storage unit which stores the case script representing the case executed in the system.

15. The non-functional evaluation assistance device according to claim 3, comprising
system model storage unit which stores the system model; and
case script storage unit which stores the case script representing the case executed in the system.

16. The non-functional evaluation assistance device according to claim 4, comprising
system model storage unit which stores the system model; and
case script storage unit which stores the case script representing the case executed in the system.

17. The non-functional evaluation assistance device according to claim 3, comprising:
non-functional requirement storage unit which stores the non-functional requirement; and
non-functional evaluation determination unit which compares the non-functional evaluation calculation result with the non-functional requirement, and determines whether or not the non-functional evaluation calculation result satisfies the non-functional requirement.

18. The non-functional evaluation assistance device according to claim 4, comprising:
non-functional requirement storage unit which stores the non-functional requirement; and
non-functional evaluation determination unit which compares the non-functional evaluation calculation result with the non-functional requirement, and determines whether or not the non-functional evaluation calculation result satisfies the non-functional requirement.

19. The non-functional evaluation assistance device according to claim 5, comprising:
non-functional requirement storage unit which stores the non-functional requirement; and
non-functional evaluation determination unit which compares the non-functional evaluation calculation result with the non-functional requirement, and determines whether or not the non-functional evaluation calculation result satisfies the non-functional requirement.
